(19) United States
(12) Patent Application Publication
(10) Pub. No.: US 2026/0328656 A1
(43) Pub. Date: Oct. 22, 2026

(54) FORMATION GAS ANALYSIS SYSTEM AND METHOD OF ANALYZING A FORMATION GAS

(71) Applicant: GM GLOBAL TECHNOLOGY OPERATIONS LLC, Detroit, MI (US)

(72) Inventors: Erik D. Huemiller, Troy, MI (US); Chariton Klavin, Davisburg, MI (US); Thaddeus Ezeh, Rochester Hills, MI (US); William Reginald Collin, Dearborn, MI (US); Debejyo Chakraborty, Novi, MI (US); Phillip W. Stevens, Goodrich, MI (US); Sean R. Wagner, Shelby Township, MI (US); James R. Salvador, East Lansing, MI (US); Mohamed Kulaib, Dearborn Heights, MI (US)

(73) Assignee: GM GLOBAL TECHNOLOGY OPERATIONS LLC, Detroit, MI (US)

(21) Appl. No.: 19/181,625

(22) Filed: Apr. 17, 2025

(51) Int. Cl. G01N 1/24; H01M 10/44; H01M 10/48; H01M 50/358; B60L 50/64

(52) U.S. Cl. CPC G01N 1/24; H01M 10/441; H01M 10/482; H01M 50/358; B60L 50/64; G01N 2001/248; H01M 2220/20

(57) ABSTRACT

A formation gas analysis system includes a formation chamber defining a cavity and configured for conducting a formation cycle of a secondary energy storage device within the cavity to generate a formation gas. The storage device has a rigid metal outer enclosure that remains at least partially unsealed during the formation cycle. The system includes a vacuum pump; a vent line interconnecting the secondary energy storage device and the vacuum pump; a first valve and second flow controller spaced apart from one another along the vent line and disposed between the formation chamber and the vacuum pump; a pressure gauge disposed between the first valve and second flow controller; a third valve disposed between the pressure gauge and the second flow controller; and a gas analyzer configured for determining a composition of the formation gas. A method of analyzing a formation gas is also described.

### INTRODUCTION

The disclosure relates to a formation gas analysis system and a method of analyzing a formation gas.

Energy storage devices, such as batteries, are useful for converting chemical energy into electrical energy, and may be described as primary or secondary. Primary energy storage devices are generally non-rechargeable, whereas secondary energy storage devices are readily rechargeable and may be restored to a full charge after use. As such, secondary energy storage devices may be useful for applications such as powering electronic devices, tools, machinery, and vehicles. For example, secondary energy storage devices for vehicle applications may be recharged external to the vehicle via a plug-in electrical outlet, or onboard the vehicle via a regenerative event.

One type of secondary energy storage device, a lithium ion secondary battery, may include a negative electrode or anode, a positive electrode or cathode, and an electrolyte disposed between the positive and negative electrodes. The negative electrode may be formed from a material that is capable of incorporating and releasing lithium ions during charging and discharging of the lithium ion secondary battery. More specifically, during charging of the lithium ion secondary battery, lithium ions may move from the positive electrode to the negative electrode and embed in the material. Conversely, during battery discharge, lithium ions may be released from the material and move from the negative electrode to the positive electrode. During a break-in or formation cycle of the lithium ion secondary battery, one or more formation gases may be produced as part of preparing the lithium ion secondary battery for use.

### SUMMARY

A formation gas analysis system includes a formation chamber defining a cavity therein and a secondary energy storage device disposed within the cavity and having a rigid metal outer enclosure that is at least partially unsealed. The formation chamber is configured for conducting a formation cycle of the secondary energy storage device within the cavity to generate a formation gas, wherein the rigid metal outer enclosure remains at least partially unsealed during the formation cycle. The formation gas analysis system also includes a vacuum pump configured to remove the formation gas from the secondary energy storage device and a vent line interconnecting the secondary energy storage device and the vacuum pump and configured for transmitting the formation gas from the secondary energy storage device. In addition, the formation gas analysis system includes a first valve and a second flow controller each disposed in fluid communication with the vent line, spaced apart from one another along the vent line, and disposed between the formation chamber and the vacuum pump. The formation gas analysis system also includes a pressure gauge disposed between the first valve and the second flow controller on the vent line; a third valve disposed in fluid communication within the vent line and disposed between the pressure gauge and the second flow controller; and a gas analyzer disposable in fluid communication with the vent line and configured for determining a composition of the formation gas.

In one aspect, the formation gas analysis system may further include a mass flow controller disposed in fluid communication with the vent line between the secondary energy storage device and the gas analyzer and configured for introducing a reference gas to the vent line.

In an additional aspect, the first valve may be disposed between the secondary energy storage device and the pressure gauge on the vent line. The first valve may be a 6-port valve that is transitionable between a filling position and a measurement position. The 6-port valve may include a sampling loop configured for transmitting a sample of the formation gas within the 6-port valve and defines a first port in fluid communication with the secondary energy storage device; a second port in fluid communication with the sampling loop and the first port when the 6-port valve is disposed in the filling position; a third port in fluid communication with the gas analyzer; a fourth port in fluid communication with the mass flow controller and the gas analyzer when the 6-port valve is disposed in the filling position; a fifth port in fluid communication with the sampling loop and the vacuum pump when the 6-port valve is disposed in the filling position; and a sixth port in fluid communication with the vacuum pump and the fifth port when the 6-port valve is disposed in the filling position. The first port may be in fluid communication with the secondary energy storage device, the sixth port, and the vacuum pump when the 6-port valve is disposed in the measurement position. The second port may be in fluid communication with the sampling loop, the third port, and the gas analyzer when the 6-port valve is disposed in the measurement position. The third port may be in fluid communication with the gas analyzer and the second port when the 6-port valve is disposed in the measurement position. The fourth port may be in fluid communication with the mass flow controller, the fifth port, and the sampling loop when the 6-port valve is disposed in the measurement position. The fifth port may be in fluid communication with the sampling loop, the fourth port, and the mass flow controller when the 6-port valve is disposed in the measurement position. The sixth port may be in fluid communication with the first port and the vacuum pump when the 6-port valve is disposed in the measurement position.

In another aspect, the formation gas analysis system may further include a plurality of secondary energy storage devices disposed within the cavity and each configured to generate a respective formation gas. The formation gas analysis system may also include a plurality of vent lines each disposed in fluid communication with a respective one of the plurality of secondary energy storage devices and configured for transmitting the respective formation gas of each of the plurality of secondary energy storage devices from the cavity. The formation gas analysis system may additionally include an exhaust manifold disposed in fluid communication with each of the plurality of vent lines and configured to collect the respective formation gas generated by each of the plurality of secondary energy storage devices and form an aggregated gas. The formation gas analysis system may also include a plurality of 6-port valves each disposed in fluid communication with the mass flow controller, a respective one of the plurality of vent lines, and the gas analyzer as the plurality of 6-port valves each transition between the filling position and the measurement position. The formation gas analysis system may further include a plurality of pressure gauges each disposed on a respective one of the plurality of vent lines between the exhaust manifold and a respective one of the plurality of 6-port valves. The formation gas analysis system may additionally include a plurality of needle valves each disposed in fluid communication with the exhaust manifold and a respective one of the plurality of vent lines and disposed between a respective one of the plurality of pressure gauges and the exhaust manifold along the respective one of the plurality of vent lines.

In a further aspect, the respective formation gas of each of the plurality of secondary energy storage devices may be independently measurable by the gas analyzer.

In one aspect, a respective one of the plurality of needle valves may cooperate with a respective one of the pressure gauges for each of the plurality of secondary energy storage devices to control a head space pressure of each of the plurality of secondary energy storage devices so that the gas analyzer measures the head space pressure of one of the plurality of secondary energy storage devices independently from measuring the head space pressure of another of the plurality of secondary energy storage devices.

In an additional aspect, the respective formation gas from a selected one of the plurality of secondary energy storage devices may be transmitted to the gas analyzer and the respective formation gas of a remainder of each of the plurality of secondary energy storage devices is not transmitted to the gas analyzer.

A formation gas analysis system includes a formation chamber defining a cavity therein and a plurality of secondary energy storage devices disposed within the cavity and each having a rigid metal outer enclosure that is unsealed. The formation chamber is configured for conducting a formation cycle of each of the plurality of secondary energy storage devices within the cavity to generate a respective formation gas of each of the plurality of secondary energy storage devices, wherein the rigid metal outer enclosure remains unsealed during the formation cycle. The formation gas analysis system further includes a vacuum pump configured to remove the respective formation gas from each of the plurality of secondary energy storage devices; and a plurality of vent lines interconnecting each of the plurality of secondary energy storage devices and the vacuum pump and configured for transmitting the respective formation gas from each of the plurality of secondary energy storage devices. The formation gas analysis system also includes a plurality of first valves each disposed in fluid communication with a respective one of the plurality of vent lines and disposed between the formation chamber and the vacuum pump. The formation gas analysis system additionally includes a plurality of second flow controllers each disposed in fluid communication with a respective one of the plurality of vent lines, spaced apart from a respective one of the plurality of first valves along the respective one of the plurality of vent lines, and disposed between the formation chamber and the vacuum pump. The formation gas analysis chamber also includes a plurality of pressure gauges each disposed between the respective one of the plurality of first valves and the respective one of the plurality of second flow controllers on the respective one of the plurality of vent lines. The formation gas analysis system further includes a gas analyzer configured for analyzing a composition of the respective formation gas of each of the plurality of secondary energy storage devices; and a gas multiplexer disposed in fluid communication with the gas analyzer and configured for sequentially conveying the respective formation gas of each of the plurality of secondary energy storage devices to the gas analyzer. The gas multiplexer is disposed in fluid communication with each of the plurality of vent lines and conveys the respective formation gas of a single one of the plurality of secondary energy storage devices to the gas analyzer at a time.

In one aspect, the plurality of secondary energy storage devices may be arranged in parallel within the cavity. The formation gas analysis system may further include a plurality of vent canisters each disposed in fluid communication with a respective one of the plurality of secondary energy storage devices. Each of the plurality of first valves may be disposed in fluid communication with a respective one of the plurality of vent canisters; and each of the plurality of second flow controllers may be configured as a needle valve.

A method of analyzing a formation gas includes conducting a formation cycle of each of a plurality of secondary energy storage devices by initially charging and discharging each of the plurality of secondary energy storage devices within a formation chamber defining a cavity therein to generate a respective formation gas of each of the plurality of secondary energy storage devices, wherein each of the plurality of secondary energy storage devices is disposed within the cavity and has a rigid metal outer enclosure that is unsealable during the formation cycle. The method also includes removing the respective formation gas from each of the plurality of secondary energy storage devices through a respective one of a plurality of vent lines in fluid communication with each of the plurality of secondary energy storage devices. The method further includes conveying the respective formation gas to a gas analyzer disposed in fluid communication with each of the plurality of vent lines and configured for determining a composition of the respective formation gas. In addition, the method includes individually analyzing a selected, respective formation gas of one of the plurality of secondary energy storage devices with the gas analyzer over the formation cycle while venting a non-selected, respective formation gas of another one of the plurality of secondary energy storage devices with a vacuum pump configured to remove the non-selected, respective formation gas from the cavity to thereby analyze the composition of the selected, respective formation gas over the formation cycle.

In one aspect, the method may further include introducing a reference gas to the plurality of vent lines through a mass flow controller disposed in fluid communication with the plurality of vent lines.

In an additional aspect, removing may include collecting the reference gas in an exhaust manifold disposed in fluid communication with the plurality of vent lines and the vacuum pump.

In another aspect, the method may further include controlling a head space pressure of each of the plurality of secondary energy storage devices with a plurality of pressure gauges each disposed in fluid communication with a respective one of the plurality of vent lines; and a plurality of needle valves each disposed in fluid communication with the respective one of the plurality of vent lines and disposed between the exhaust manifold and a respective one of the plurality of pressure gauges. A respective one of the plurality of needle valves may cooperate with a respective one of the plurality of pressure gauges to control the head space pressure of each of the plurality of secondary energy storage devices so that the gas analyzer measures the head space pressure of one of the plurality of secondary energy storage devices independently from measuring the head space pressure of another of the plurality of secondary energy storage devices.

In a further aspect, conveying the respective formation gas to the gas analyzer may include routing the respective formation gas through one of a plurality of first valves each disposed in fluid communication with a respective one of the plurality of vent lines and spaced between a respective one of the plurality of pressure gauges and a respective one of the secondary energy storage devices. Further, each of the plurality of first valves may be a 6-port valve that is transitionable between a filling position and a measurement position according to at least one of a time schedule and a voltage schedule. The 6-port valve may include a sampling loop configured for transmitting a sample of the formation gas within the 6-port valve. The 6-port valve may define a first port in fluid communication with the respective secondary energy storage device; a second port in fluid communication with the sampling loop and the first port when the 6-port valve is disposed in the filling position; a third port in fluid communication with the gas analyzer; a fourth port in fluid communication with the mass flow controller and the gas analyzer when the 6-port valve is disposed in the filling position; a fifth port in fluid communication with the sampling loop and the vacuum pump when the 6-port valve is disposed in the filling position; and a sixth port in fluid communication with the vacuum pump and the fifth port when the 6-port valve is disposed in the filling position. The first port may be in fluid communication with the respective secondary energy storage device, the sixth port, and the vacuum pump when the 6-port valve is disposed in the measurement position. The second port may be in fluid communication with the sampling loop, the third port, and the gas analyzer when the 6-port valve is disposed in the measurement position. The third port may be in fluid communication with the gas analyzer and the second port when the 6-port valve is disposed in the measurement position. The fourth port may be in fluid communication with the mass flow controller, the fifth port, and the sampling loop when the 6-port valve is disposed in the measurement position. The fifth port may be in fluid communication with the sampling loop, the fourth port, and the mass flow controller when the 6-port valve is disposed in the measurement position; and the sixth port may be in fluid communication with the first port and the vacuum pump when the 6-port valve is disposed in the measurement position.

In one aspect, the method may further include independently exhausting the respective formation gas of each of the plurality of secondary energy storage devices by transitioning a selected 6-port valve to the filling position such that the respective formation gas flows from a selected one of the plurality of secondary energy storage devices to the exhaust manifold through the sampling loop and the reference gas flows to the gas analyzer.

In an additional aspect, the method may further include independently assessing the respective formation gas of each of the plurality of secondary energy storage devices with the gas analyzer by transitioning the selected 6-port valve to the measurement position such that the respective formation gas and the reference gas in the sampling loop flows to the gas analyzer and a remainder of the respective formation gas that is not in the sampling loop is drawn from the selected one of the plurality of secondary energy storage devices to the exhaust manifold by the vacuum pump.

In another aspect, independently assessing may include ensuring that the respective formation gas from a selected one of the plurality of secondary energy storage devices is transmitted to the gas analyzer and each respective formation gas of a remainder of the plurality of secondary energy storage devices is not transmitted to the gas analyzer.

In a further aspect, conveying may include routing the respective formation gas of each of the plurality of secondary energy storage devices to a gas multiplexer configured for sequentially analyzing a composition of the respective formation gas according to at least one of a time schedule and a voltage schedule. Further, the gas multiplexer may be disposed in fluid communication with each of the plurality of vent lines and the gas analyzer.

In one aspect, individually analyzing may include arranging the plurality of secondary energy storage devices in parallel within the cavity of the formation chamber and measuring a composition of the respective formation gas of one of the plurality of secondary energy storage devices at a time. The gas multiplexer may be disposed in fluid communication with each of the plurality of vent lines between a respective one of a plurality of first valves; and a respective one of a plurality of second flow controllers each configured as a needle valve and each disposed in fluid communication with a respective one of the first valves and the vacuum pump along a respective one of the plurality of vent lines. A plurality of vent canisters may each be disposed in fluid communication with a respective one of the plurality of secondary energy storage devices and a respective one of the plurality of first valves. A plurality of pressure gauges may each be disposed on a respective one of the plurality of vent lines between a respective one of the plurality of first valves and a respective one of the plurality of second flow controllers.

In an additional aspect, a vehicle may include a secondary energy storage device having a formation gas analyzed by the method.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is a schematic illustration of a side view of a secondary energy storage device.

FIG. 2 is a schematic illustration of an exploded, perspective view of a vehicle including a plurality of the secondary energy storage devices of FIG. 1 that are arranged into a plurality of secondary energy storage modules arranged into a secondary energy storage pack.

FIG. 3 is a schematic illustration and block diagram of a formation gas analysis system configured for analyzing a formation gas generated by the secondary energy storage device of FIG. 1.

FIG. 4 is a schematic illustration and block diagram of another example of the formation gas analysis system of FIG. 3.

FIG. 5 is a schematic illustration and block diagram of an additional example of the formation gas analysis system of FIG. 3.

FIG. 6 is a schematic illustration and block diagram of a further example of the formation gas analysis system of FIG. 3 including a plurality of first valves each configured as a 6-port valve.

FIG. 7A is a schematic illustration of a cut-away plan view of the 6-port valve of FIG. 6 configured in a filling position.

FIG. 7B is a schematic illustration of a cut-away plan view of the 6-port valve of FIGS. 6 and 7A configured in a measurement position.

FIG. 8 is a schematic illustration and block diagram of an aspect of the formation gas analysis system of FIG. 3.

FIG. 9 is a schematic illustration and block diagram of an additional aspect of the formation gas analysis system of FIG. 3.

FIG. 10 is a schematic illustration and block diagram of another aspect of the formation gas analysis system of FIG. 3.

FIG. 11 is a schematic illustration and block diagram of a further aspect of the formation gas analysis system of FIG. 3.

FIG. 12 is a schematic illustration and block diagram of another exemplary aspect of the formation gas analysis system of FIG. 3.

FIG. 13 is a schematic illustration and block diagram of an additional exemplary aspect of the formation gas analysis system of FIG. 3.

FIG. 14 is a schematic illustration and block diagram of a further exemplary aspect of the formation gas analysis system of FIG. 3.

FIG. 15 is a schematic illustration and block diagram of yet another exemplary aspect of the formation gas analysis system of FIG. 3.

FIG. 16 is a schematic flow diagram of a method of analyzing the formation gas of the secondary energy storage device of FIG. 1.

### DETAILED DESCRIPTION

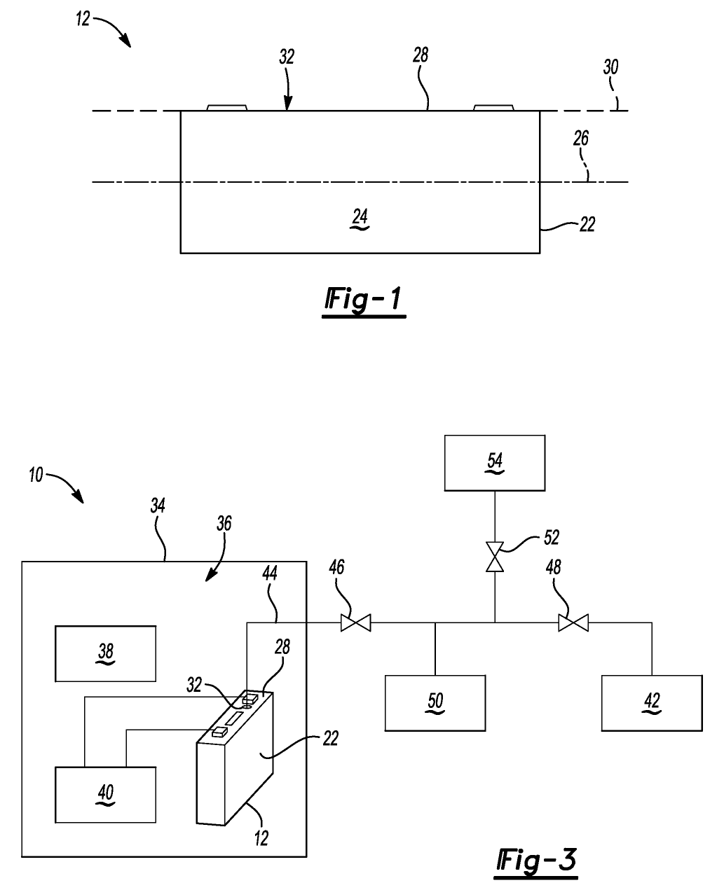

Referring to the Figures, wherein like reference numerals refer to like elements, a formation gas analysis system 10 (FIGS. 3-15), a secondary energy storage device 12 (FIG. 1), and a method 14 (FIG. 16) of analyzing a formation gas generated by the secondary energy storage device 12 are shown generally. The formation gas analysis system 10 and method 14 may be useful for applications requiring measurement, analysis, and monitoring of a composition of the formation gas produced by the secondary energy storage device 12 during a formation cycle, i.e., an initial or break-in cycle, of the secondary energy storage device 12 and for applications requiring secondary energy storage devices 12 having excellent quality and robust operational integrity during operation under various conditions.

In particular, the formation gas analysis system 10 and method 14 may be useful for applications requiring in-process quality monitoring during manufacturing operations of secondary energy storage devices 12. That is, the system 10 and method 14 may analyze the composition of the formation gas for one or more secondary energy storage devices 12 during initial cycling of the one or more secondary energy storage devices 12 so that quality and predicted operational performance of the one or more secondary energy storage devices 12 may be evaluated. As such, the system 10 and method 14 may be suitable for in-process quality monitoring of high-volume manufacturing operations that produce secondary energy storage devices 12 having excellent quality and performance.

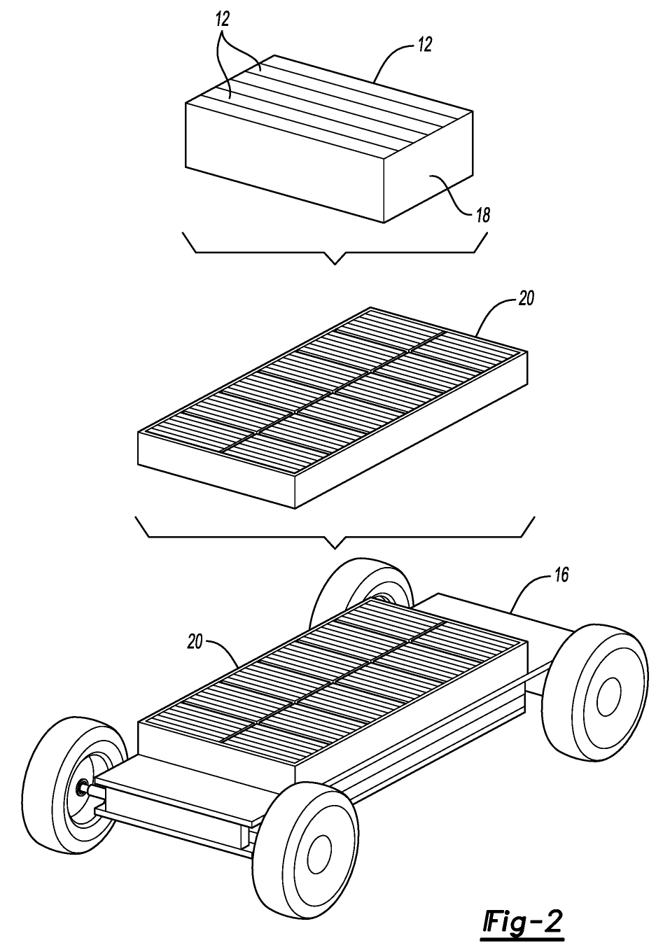

In one non-limiting example, the secondary energy storage device 12 may be a lithium ion secondary battery as shown in FIG. 1. That is, the secondary energy storage device 12 may be useful for applications requiring lithium ion secondary batteries having excellent electrical conductivity, mechanical integrity, specific energy capacity, performance, manufacturing cost, and operating life. Therefore, the secondary energy storage device 12 may be useful for a variety of applications, such as, but not limited to, electronic devices, tools, machinery, and vehicles 16 (FIG. 2). For example, the secondary energy storage device 12 may be useful for lithium ion secondary batteries for electric and hybrid electric vehicles. However, it is to be appreciated that the secondary energy storage device 12 may also be useful for non-automotive applications, such as, but not limited to, household and industrial power tools and consumer electronic devices.

Referring now to FIG. 2 and for purposes of general explanation pertaining to automotive applications, a plurality of secondary energy storage devices 12 may be combined to form a secondary energy storage module 18, e.g., a lithium ion secondary battery module. The secondary energy storage module 18 may be useful for automotive applications such as a hybrid electric vehicle (HEV), an electric vehicle (EV), a plug-in hybrid electric vehicle (PHEV), and the like. Further, a plurality of secondary energy storage modules 18 may be combined to form a secondary energy storage pack 20, e.g., a lithium ion secondary battery pack, as also shown in FIG. 2. By way of example, the secondary energy storage pack 20 may be sufficiently sized to provide a voltage for powering an HEV, an EV, a PHEV, and the like, e.g., approximately 300 to 800 volts or more, depending on the required application.

Referring again to FIG. 2, the secondary energy storage module 18 may include a plurality of secondary energy storage devices 12 positioned adjacent to and spaced from one another. As such, the secondary energy storage device 12 may be suitable for stacking. More specifically and as best shown in FIG. 1, in one example, the secondary energy storage device 12 includes a rigid metal outer enclosure 22 that is at least partially unsealed during manufacture. The rigid metal outer enclosure 22 may have a rectangular prism shape or cuboid shape and the secondary energy storage device 12 may be characterized as a prismatic secondary energy storage device. The rigid metal outer enclosure 22 may be formed from a metal, such as aluminum or steel, and may define an interior that may be sealed after manufacture to enclose an interior portion of a cathode or positive electrode (not shown), an internal portion of an anode or negative electrode (not shown), a separator (not shown), and an electrolyte (not shown). Alternatively, although not shown, the rigid metal outer enclosure 22 may have another shape.

Therefore, during operation, the plurality of secondary energy storage devices 12 may be stacked or otherwise placed adjacent to each other to form a cell stack, i.e., the secondary energy storage module 18. Further, although not shown, additional layers, such as, but not limited to, frames and/or cooling layers may also be positioned in a space between individual secondary energy storage devices 12. The actual number of secondary energy storage devices 12 may be expected to vary with the desired voltage output of each secondary energy storage module 18. Likewise, the number of interconnected secondary energy storage modules 18 may vary to produce the total output voltage for a specific application.

In general, during operation of the secondary energy storage device 12, a chemical redox reaction may transfer electrons between a region of relatively negative potential to a region of relatively positive potential to thereby cycle, i.e., charge and discharge, the secondary energy storage device 12 and the secondary energy storage pack 20 to provide voltage to power applications. In particular, a plurality of lithium ions (not shown) may transfer between the positive electrode and the negative electrode during charging and discharging of the secondary energy storage device 12.

Therefore, the secondary energy storage device 12, formation gas analysis system 10, and method 14 may be useful for automotive applications such as, but not limited to, vehicles 16 (FIG. 2) including internal combustion engine vehicles, electric vehicles, hybrid vehicles, and the like. For example, the vehicle 16 may be a motor vehicle powered by a motive power source including at least one of an internal combustion engine, an electric motor, and an energy storage device, and the vehicle 16 may include the secondary energy storage device 12 having the formation gas analyzed by the method 14 (FIG. 16).

Further, the vehicle 16 may be configured for autonomous or automated driving in which the vehicle 16 may be controlled or driven by technology including hardware and software, whether remote to the vehicle 16 or onboard the vehicle 16, that is capable of driving the vehicle 16 without active physical control by a human operator. For example, autonomous or automated driving tasks may include, but are not limited to, object and event detection, recognition, and classification; object and event response; maneuver planning; steering, turning, lane-keeping, signaling, and lane changing; and acceleration and deceleration.

Alternatively, the secondary energy storage device 12, formation gas analysis system 10, and method 14 may be useful for non-automotive applications such as, but not limited to, aerospace, aviation, marine, mass transportation, agricultural, industrial, and rail applications. For example, the vehicle 16 may be, but is not limited to, a commercial vehicle, industrial vehicle, passenger vehicle, automated guided vehicle (AGV), aircraft, watercraft, train, trolley, bus, or the like. It is also contemplated that the vehicle 16 may be a mobile platform, such as an airplane, all-terrain vehicle (ATV), boat, personal movement apparatus, robot, and the like to accomplish the purposes of this disclosure.

### Secondary energy storage device

Referring now to FIG. 1, the rigid metal outer enclosure 22 of the secondary energy storage device 12 may include a front face 24 extending along a central longitudinal axis 26. That is, the front face 24 may have a generally rectangular shape, may be formed from metal, and may have a longest dimension extending along the central longitudinal axis 26. The rigid metal outer enclosure 22 may also include a cap plate 28 that contacts and is disposed perpendicular to the front face 24 and extends along an axis 30 that is parallel to the central longitudinal axis 26. As best shown in FIG. 3, the cap plate 28 may also define a vent 32 configured for alternatingly fluidly communicating with and sealing off the interior of the secondary energy storage device 12 from an environment ambient to the cap plate 28. For purposes of portions of this description, the rigid metal outer enclosure 22 may remain at least partially unsealed, e.g., vented through an open or unsealed vent 32 or otherwise unsealed, during assembly, manufacture, and quality control operations. That is, as set forth in more detail below, the method 14 may include generating the formation gas during open venting in which the formation gas is continuously removed from the secondary energy storage device 12. Alternatively, in other arrangements, the method 14 and system 10 may be useful for intermittently venting the formation gas from the secondary energy storage device 12.

### Formation gas analysis system

Referring now to FIG. 3, the formation gas analysis system 10 includes a formation chamber 34 defining a cavity 36 therein and the secondary energy storage device 12 disposed within the cavity 36. The formation chamber 34 may be generally sealed from an ambient environment and may be sized to house one or more secondary energy storage devices 12 within the cavity. The formation chamber 34 may include equipment for monitoring the secondary energy storage device 12, such as, but not limited to, a temperature probe 38 disposed within the cavity 36 and configured to monitor a temperature of the secondary energy storage device 12 and a battery cycler 40 disposed within the cavity 36 and configured to provide a charge current to the secondary energy storage device 12 and draw a discharge current from the secondary energy storage device 12.

The formation chamber 34 is configured for conducting 124 (FIG. 16) the formation cycle of the secondary energy storage device 12 within the cavity 36 to generate the formation gas. The formation cycle may be a specialized manufacturing process that the secondary energy storage device 12 may undergo after initial assembly but before being deployed to power a product or machine. That is, the formation cycle may be the first or initial cycle(s) of the secondary energy storage device 12 and may create a solid electrolyte interphase (SEI) layer on the anode, activate electrode materials to a usable state, and stabilize internal chemistry. Generally, during the formation cycle, the secondary energy storage device 12 may first rest after assembly to allow the electrolyte to fully penetrate the components of the secondary energy storage device 12 in a wetting phase, i.e., wetting before cell initial charging (WBCIC). A first charge of the secondary energy storage device 12 may be conducted at a comparatively slow rate to cause controlled decomposition of the electrolyte at the anode, form the protective SEI layer, and generate one or more formation gases. The formation gas(es) may then be removed from the secondary energy storage device 12 continuously (open venting) or at intervals (intermittent venting). Several complete charge-discharge cycles may be performed at progressively higher charge rates within the formation chamber 34 to stabilize the SEI layer, fully activate the electrode materials, and test performance characteristics of the secondary energy storage device 12.

In-process quality monitoring of the respective formation gases generated during high-volume manufacturing operations of multiple secondary energy storage devices 12 may be useful for monitoring, predicting, and/or diagnosing process anomalies. For example, formation gases produced at specific voltage windows may be indicative of parasitic side reactions and potential processes anomalies. Further, detection of or deviations in respective quantities or ratios of certain signature gases in the formation gas, such as, but not limited to, methane, ethene, ethane, butane, hydrogen, carbon monoxide, carbon dioxide, and the like, may correlate to certain manufacturing process anomalies or structural deviations for the secondary energy storage device 12. Identifying such process anomalies and/or structural deviations earlier in the manufacturing process of the secondary energy storage device 12 may reduce manufacturing cost, rework, and non-value-added downstream processes. Therefore, the in-process quality monitoring and formation gas analysis provided by the system 10 and method 14 described herein may accelerate root cause analysis of manufacturing process anomalies by pointing to a specific time or voltage interval for investigation rather than simply providing a pass/fail assessment of an assembled secondary energy storage device 12. Advantageously, the system 10 and method 14 are also scalable to high-volume manufacturing processes.

Referring again to FIG. 3, the formation gas analysis system 10 also includes a vacuum pump 42 configured to remove the formation gas from the secondary energy storage device 12. That is, the system 10 also includes a vent line 44 interconnecting the secondary energy storage device 12 and the vacuum pump 42 and configured for transmitting the formation gas from the secondary energy storage device 12, e.g., draw the formation gas from the secondary energy storage device 12 and cavity 36 by vacuum.

In addition, as described with continued reference to FIG. 3, the formation gas analysis system 10 may include gas handling components that are configured for conveying the formation gas and maintaining a consistent pressure within the formation gas analysis system 10. More specifically, as shown in FIG. 3, the formation gas analysis system 10 includes a first valve 46 and a second flow controller 48 each disposed in fluid communication with the vent line 44, spaced apart from one another along the vent line 44, and disposed between the formation chamber 34 and the vacuum pump 42. For example, the first valve 46 and the second flow controller 48 may each be configured as valves for intermittently restricting flow of the formation gas within the vent line 44. In one example, the first valve 46 may be configured as an on/off valve that alternately allows for unimpeded flow and restricts flow completely. In one example, the second flow controller 48 may be configured as a needle valve, e.g., a linear motion valve configured for precise flow control that may include a long, thin, needle-like disc that may translate linearly within a seat to regulate flow.

Referring again to FIG. 3, the formation gas analysis system 10 also includes a pressure gauge 50 disposed between the first valve 46 and the second flow controller 48 on the vent line 44 and configured for measuring a pressure within the vent line 44. Further, the formation gas analysis system 10 includes a third valve 52 or valve disposed in fluid communication with the vent line 44 and disposed between the pressure gauge 50 and the second flow controller 48. The third valve 52 may be configured as an on/off valve.

As described with continued reference to FIG. 3, the formation gas analysis system 10 also includes a gas analyzer 54 disposable in fluid communication with the vent line 44 and configured for determining the composition of the formation gas. That is, at times, the formation gas may be routed to the gas analyzer 54 through the vent line 44 for measurement and analysis, and at other times, the formation gas may be sealed off from the gas analyzer 54 and may instead be vented from the system 10 via the vacuum pump 42. The gas analyzer 54 may include at least one of a mass spectrometer, a gas sensor, a Fourier-transform infrared spectrometer, and a gas chromatograph that may measure, analyze, and monitor the composition of the formation gas generated by the secondary energy device 12 in the cavity 36 of the formation chamber 34. For example, the gas analyzer 54 may be a dedicated gas sensor configured to detect a specific species of gas such as, but not limited to, hydrogen, carbon monoxide, and carbon dioxide. Alternatively, the gas analyzer 54 may be configured to detect a total hydrocarbon in the formation gas. As such, periodically in time or at certain voltage milestones of the secondary energy storage device 12, the composition of the formation gas may be measured to ascertain a time evolution of gas generation during the formation cycle.

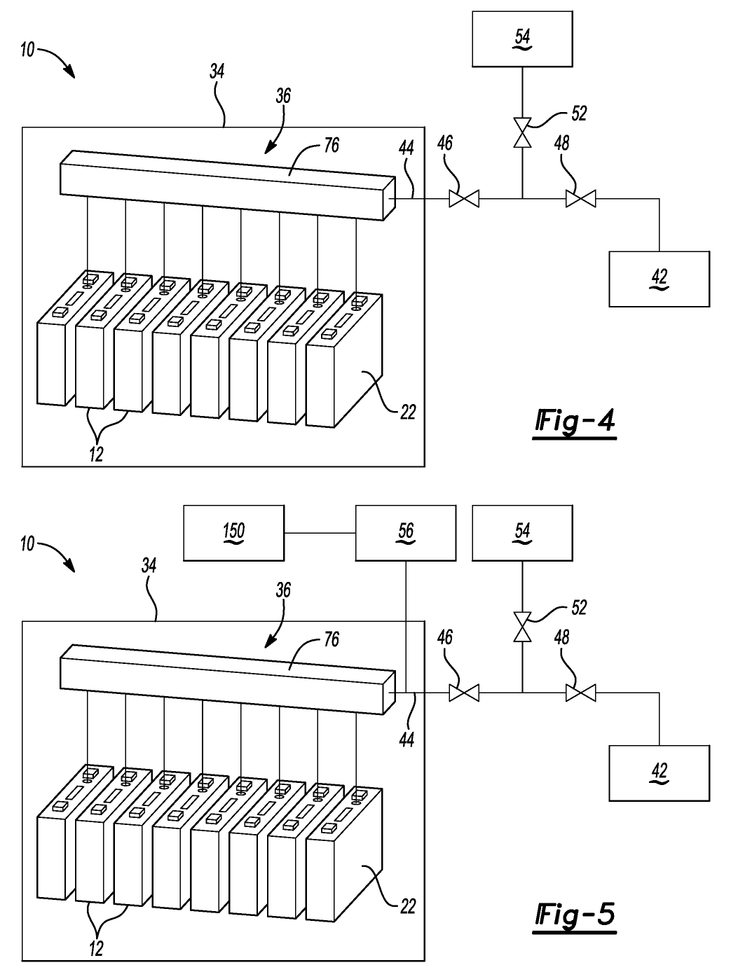

Further, as best shown in FIG. 4, the formation gas analysis system 10 may include a plurality of secondary energy storage devices 12 disposed within the cavity 36 and each configured to generate a respective formation gas that is in fluid communication with the vent line 44. For example, the plurality of secondary energy storage devices 12 may be arranged in parallel within the formation chamber 34 so that more than one respective formation gas may be measured by the gas analyzer 54 in sequence or in aggregate as set forth in more detail below. That is, the gas analyzer 54 may measure and analyze the formation gas from a single secondary energy storage device 12 or may analyze a collective off gassing of the respective formation gas from each of the plurality of secondary energy storage devices 12.

Referring now to FIG. 5, in one aspect, the formation gas analysis system 10 may include a mass flow controller 56 disposed in fluid communication with the vent line 44 between the secondary energy storage device 12 and the gas analyzer 54 and may be configured for introducing a reference gas 150 to the vent line 44. For example, the reference gas 150 may be a calibration or trickle gas, such as helium or an inert gas, having a baseline reference composition and may be fed into the vent line 44 by the mass flow controller 56 between the formation chamber 34 and the gas analyzer 54 to thereby enable comparatively high-fidelity quantification of the formation gas generation of one or more secondary energy storage devices 12. That is, the gas analyzer 54 may compare a measurement of the formation gas to the reference gas 150 to ascertain an accurate quantification of the composition of the formation gas.

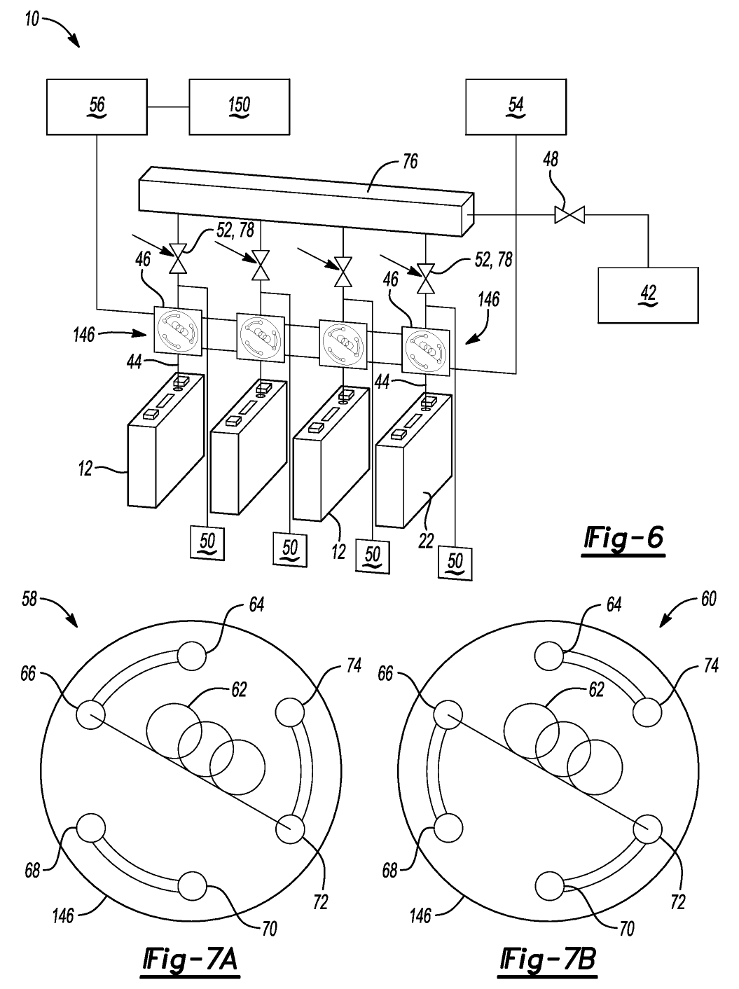

Referring now to FIG. 6, in another aspect, the first valve 46 may be disposed between the secondary energy storage device 12 and the pressure gauge 50 on the vent line 44 and may be a 6-port valve 146 that is transitionable between a filling position 58 (FIG. 7A) and a measurement position 60 (FIG. 7B).

More specifically, as described with reference to FIGS. 7A and 7B, the 6-port valve 146 may include a sampling loop 62 configured for transmitting a sample of the formation gas within the 6-port valve 146. As best shown in FIG. 7A, the 6-port valve 146 may define a first port 64 in fluid communication with the secondary energy storage device 12, a second port 66 in fluid communication with the sampling loop 62 and the first port 64 when the 6-port valve 146 is disposed in the filling position 58, and a third port 68 in fluid communication with the gas analyzer 54. In addition, the 6-port valve 146 may define a fourth port 70 in fluid communication with the mass flow controller 56 and the gas analyzer 54 when the 6-port valve 146 is disposed in the filling position 58, a fifth port 72 in fluid communication with the sampling loop 62 and the vacuum pump 42 when the 6-port valve 146 is disposed in the filling position 58, and a sixth port 74 in fluid communication with the vacuum pump 42 and the fifth port 72 when the 6-port valve 146 is disposed in the filling position 58.

As such, when the 6-port valve 146 is disposed in the filling position 58, formation gas may flow from the secondary energy storage device 12 to the vacuum pump 42 or exhaust through the sampling loop 62 and the reference gas 150 may flow to the gas analyzer 54.

As best shown in FIG. 7B, the first port 64 may be in fluid communication with the secondary energy storage device 12, the sixth port 74, and the vacuum pump 42 when the 6-port valve 146 is disposed in the measurement position 60. The second port 66 may be in fluid communication with the sampling loop 62, the third port 68, and the gas analyzer 54 when the 6-port valve 146 is disposed in the measurement position 60. The third port 68 may be in fluid communication with the gas analyzer 54 and the second port 66 when the 6-port valve 146 is disposed in the measurement position 60. The fourth port 70 may be in fluid communication with the mass flow controller 56, the fifth port 72, and the sampling loop 62 when the6-port valve 146 is disposed in the measurement position 60. The fifth port 72 may be in fluid communication with the sampling loop 62, the fourth port 70, and the mass flow controller 56 when the 6-port valve 146 is disposed in the measurement position 60. The sixth port 74 may be in fluid communication with the first port 64 and the vacuum pump 42 when the 6-port valve 146 is disposed in the measurement position 60.

As such, after a period of time or according to a targeted voltage schedule, the 6-port valve 146 may transition to the measurement position 60 and the contents within the sampling loop 62, e.g., the formation gas and any reference gas 150, may be fed to the gas analyzer 54 while the selected secondary energy storage device 12 continues off-gassing to the vacuum pump 42, i.e., while a non-sampled portion of the formation gas flows to the vacuum pump 42.

Therefore, as described with reference to FIG. 6, each 6-port valve 146 may be cycled between the filling position 58 and the measurement position 60 so that a respective formation gas of each of the plurality of secondary energy storage devices 12 may be independently measurable by the gas analyzer 54, as set forth in more detail below. That is, the respective formation gas from a selected one of the plurality of secondary energy storage devices 12 may be transmitted to the gas analyzer 54 and the respective formation gas of a remainder of each of the plurality of secondary energy storage devices 12 may not be transmitted to the gas analyzer 54.

For the example of the formation gas analysis system 10 shown in FIG. 6, the formation gas analysis system 10 may include the plurality of secondary energy storage devices 12 disposed within the cavity 36 and each configured to generate a respective formation gas. The formation gas analysis system 10 also includes a plurality of vent lines 44 each disposed in fluid communication with a respective one of the plurality of secondary energy storage devices 12 and configured for transmitting the respective formation gas of each of the plurality of secondary energy storage devices 12 from the cavity 36.

Further, as shown in FIG. 6, in this example, the formation gas analysis system 10 may also include an exhaust manifold 76 disposed in fluid communication with each of the plurality of vent lines 44 and configured to collect the respective formation gas generated by each of the plurality of secondary energy storage devices 12 and form an aggregated gas. That is, the respective formation gas of each of the plurality of secondary energy storage devices 12 may vent into, be collected by, and combine within the exhaust manifold 76 depending on a position 58, 60 of one or more of the plurality of 6-port valves 146.

That is, as shown in FIG. 6, the formation gas analysis system 10 may include a plurality of 6-port valves 146 each disposed in fluid communication with the mass flow controller 56, a respective one of the plurality of vent lines 44, and the gas analyzer 54 as the plurality of 6-port valves 146 each transition between the filling position 58 and the measurement position 60. As such, the formation gas analysis system 10 may enable selecting one of the plurality of secondary energy storage devices 12 for compositional analysis by the gas analyzer 54. In addition, the formation gas analysis system 10 may enable selecting each of the plurality of secondary energy storage devices 12 sequentially for compositional analysis by the gas analyzer 54.

As described with continued reference to FIG. 6, the formation gas analysis system 10 may also include a plurality of pressure gauges 50 each disposed on a respective one of the plurality of vent lines 44 between the exhaust manifold 76 and the respective one of the plurality of 6-port valves 146. Further, the formation gas analysis system 10 may also include a plurality of needle valves 78 each disposed in fluid communication with the exhaust manifold 76 and a respective one of the plurality of vent lines 44 and disposed between a respective one of the plurality of pressure gauges 50 and the exhaust manifold 76 along the respective one of the plurality of vent lines 44.

During operation, a respective one of the plurality of needle valves 78 may cooperate with a respective one of the pressure gauges 50 for each of the plurality of secondary energy storage devices 12 to control a head space pressure of each of the plurality of secondary energy storage devices 12 so that the gas analyzer 54 measures the head space pressure of one of the plurality of secondary energy storage devices 12 independently from measuring the head space pressure of another of the plurality of secondary energy storage devices 12. Therefore, the respective formation gas from one of the plurality of secondary energy storage devices 12 that is selected to be measured may be transmitted to the gas analyzer 54, and the respective formation gas of a remainder of the other of the plurality of secondary energy storage devices 12 that are not selected to be measured may not be transmitted to the gas analyzer 54 but may instead be collected by the exhaust manifold 76 and exhausted from the formation gas analysis system 10 with the vacuum pump 42.

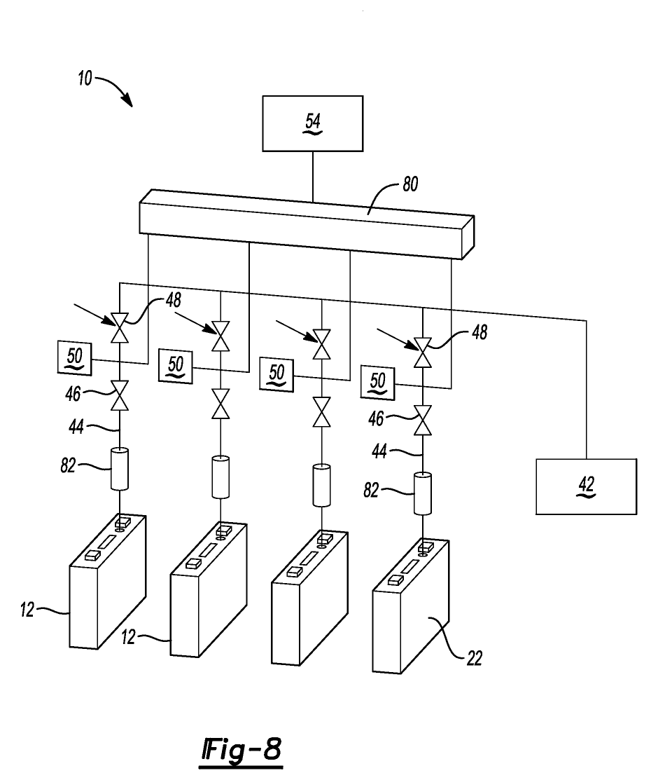

Referring now to FIG. 8, in another example, the formation gas analysis system 10 includes the formation chamber 34 defining the cavity 36 therein, and a plurality of secondary energy storage devices 12 disposed within the cavity 36 and each having the rigid metal outer enclosure 22 that is unsealed. For instance, the plurality of secondary energy devices 12 may be arranged in parallel within the cavity 36. The formation chamber 34 may be configured for conducting 124 the formation cycle of each of the plurality of secondary energy storage devices 12 within the cavity 36 to generate a respective formation gas of each of the plurality of secondary energy storage devices 12, wherein the rigid metal outer enclosure 22 remains unsealed during the formation cycle. Stated differently, the formation chamber 34 may be configured for open venting.

As described with continued reference to FIG. 8, for this example, the formation gas analysis system 10 also includes the vacuum pump 42 configured to remove the respective formation gas from each of the plurality of secondary energy storage devices 12, and a plurality of vent lines 44 interconnecting each of the plurality of secondary energy storage devices 12 and the vacuum pump 42 and configured for transmitting the respective formation gas from each of the plurality of secondary energy storage devices 12.

Further, as shown in FIG. 8, the formation gas analysis system 10 includes a plurality of first valves 46 each disposed in fluid communication with a respective one of the plurality of vent lines 44 and disposed between the formation chamber 34 and the vacuum pump 42. In this example, the plurality of first valves 46 may each be configured as an on/off valve. Likewise, the formation gas analysis system 10 includes a plurality of second flow controllers 48 each disposed in fluid communication with a respective one of the plurality of vent lines 44, spaced apart from a respective one of the plurality of first valves 46 along the respective one of the plurality of vent lines 44, and disposed between the formation chamber 34 and the vacuum pump 42. The plurality of second flow controllers 48 may each be configured as a needle valve.

Referring again to FIG. 8, the formation gas analysis system 10 also includes a plurality of pressure gauges 50 each disposed between the respective one of the plurality of first valves 46 and the respective one of the plurality of second flow controllers 48 on the respective one of the plurality of vent lines 44. The system 10 also includes the gas analyzer 54 configured for analyzing the composition of the respective formation gas of each of the plurality of secondary energy storage devices 12.

For this example, as shown in FIG. 8, the system 10 also includes a gas multiplexer 80 disposed in fluid communication with the gas analyzer 54 and configured for sequentially conveying the respective formation gas of each of the plurality of secondary energy storage devices 12 to the gas analyzer 54. The gas multiplexer 80 is disposed in fluid communication which each of the plurality of vent lines 44 and conveys the respective formation gas of a single one of the plurality of secondary energy storage devices 12 to the gas analyzer 54 at a time.

Stated differently, the gas multiplexer 80 may be a device that allows multiple formation gas sample streams to be sequentially analyzed using a single analytical instrument, which may allow for multiple sampling points, e.g., respective vent lines 44 for multiple secondary energy storage devices 12, and may reduce costs and allow for continuous monitoring of multiple formation gas streams with periodic sampling. Although not shown in detail, the gas multiplexer 80 may include multiple inlet ports each connected to a different one of the plurality of vent lines 44. Valves, such as the first valves 46 and the second flow controllers 48 configured as needle valves may control which respective formation gas flows to the gas analyzer 54. A control system (not shown) may determine a switching sequence and timing such that a single formation gas passes through to the gas analyzer 54 at a time. Further, the vacuum pump 42 may allow for purging to prevent cross-contamination between formation gas samples.

Referring again to FIG. 8, the formation gas analysis system 10 may further include a plurality of vent canisters 82 each disposed in fluid communication with a respective one of the plurality of secondary energy storage devices 12. In particular, each of the plurality of first valves 46 may be disposed in fluid communication with a respective one of the plurality of vent canisters 82. In addition, each of the plurality of second flow controllers 48 may be configured as a needle valve.

Therefore, the formation gas analysis system 10 shown in FIG. 8 may be suitable for applications requiring multiple secondary energy storage devices 12 arranged in parallel and connected to multiplexed vent lines 44 that are fed to a single gas analyzer 54, which may enable analysis of comparatively more secondary energy storage devices 12 than, for example, the system 10 of FIG. 3. As such, formation gas analysis costs per secondary energy storage device 12 may be reduced.

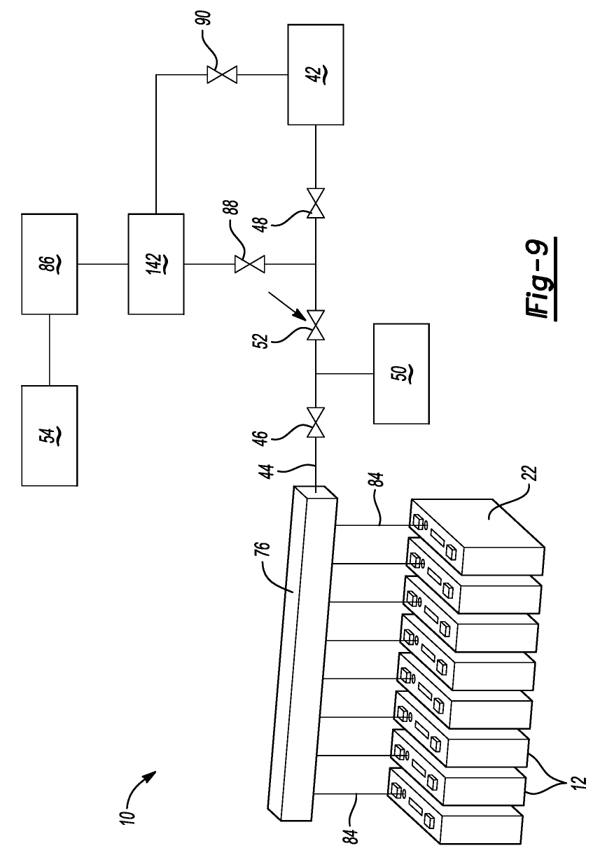

Referring now to FIG. 9, in another exemplary aspect, the formation gas analysis system 10 may further include a plurality of vent conduits 84 each disposed in fluid communication with a respective one of the plurality of secondary energy storage devices 12 and configured for transmitting the respective formation gas from the respective one of the plurality of secondary energy storage devices 12. Further, the system 10 may include the exhaust manifold 76 disposed in fluid communication with each of the plurality of vent conduits 84 and configured to collect the respective formation gas generated by each of the plurality of secondary energy storage devices 12 to form an aggregated gas.

As shown in FIG. 9, the formation gas analysis system 10 may also include a storage tank 86 disposed between and in fluid communication with the vacuum pump 42 and the gas analyzer 54. Further, the system 10 may include a step up pump 142 disposed between the second flow controller 48 and the third valve 52 and configured for pumping the aggregated gas from the exhaust manifold 76 to the storage tank 86.

For this example of FIG. 9, the formation gas analysis system 10 may also include a fourth flow controller 88 disposed between the third valve 52 and the step up pump 142. The third valve 52 may be configured as a needle valve. The system 10 may also include a fifth flow controller 90 disposed between the vacuum pump 42 and the storage tank 86. As such, for this example, the first valve 46, the second flow controller 48, the fourth flow controller 88, and the fifth flow controller 90 may be configured as on/off valves, and the third valve 52 may be configured as the needle valve.

Therefore, in operation, the formation gas analysis system 10 shown in FIG. 9 may pump the aggregated gas into the dedicated storage tank 86 via the step up pump 142. The gas analyzer 54 may then analyze the formation gases in the storage tank 86 over time before venting the formation gases by way of the vacuum pump 42 upon completion of gas analysis.

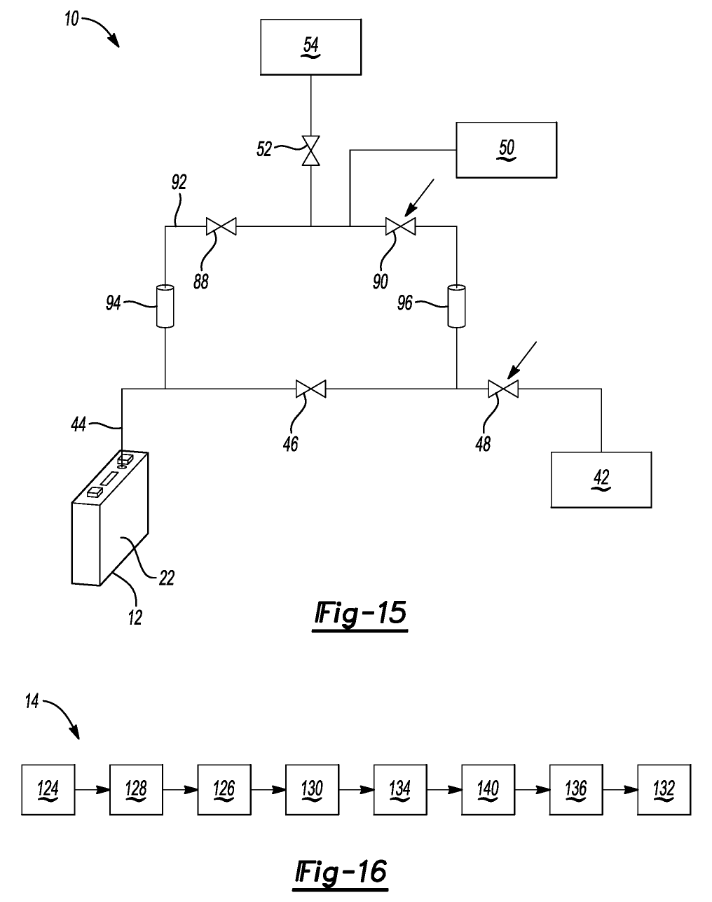

Referring now to FIG. 15, in another example that is suitable for open venting, the formation gas analysis system 10 includes the formation chamber 34 defining the cavity 36 therein and configured for conducting 124 (FIG. 16) the formation cycle of the secondary energy storage device 12 within the cavity 36 to generate the formation gas. The secondary energy storage device 12 is disposed within the cavity 36 and has the rigid metal outer enclosure 22 that remains at least partially unsealed during the formation cycle. The formation gas analysis system 10 also includes the vacuum pump 42 configured to remove the formation gas from the secondary energy storage device 12, and the vent line 44 interconnecting the secondary energy storage device 12 and the vacuum pump 42 and configured for transmitting the formation gas from the secondary energy storage device 12.

As described with continued reference to FIG. 15, the formation gas analysis system 10 also includes the first valve 46 and the second flow controller 48 each disposed in fluid communication with the vent line 44, spaced apart from one another along the vent line 44, and disposed between the formation chamber 34 and the vacuum pump 42. The first valve 46 may be configured as an on/off valve and the second flow controller 48 is configured as a needle valve. The system 10 also includes the gas analyzer 54 disposed in disconnectable, releasable fluid communication with the vent line 44 and configured for analyzing the composition of the formation gas. That is, the gas analyzer 54 may be disconnected from the vent line 44 as desired.

More specifically, with continued reference to FIG. 15, the formation gas analysis system 10 also includes a sensing line 92 configured for transmitting the formation gas from the vent line 44 to the gas analyzer 54. The sensing line 92 includes a first connector 94 that is releasably connected to the vent line 44 between the secondary energy storage device 12 on the first valve 46 to dispose the sensing line 92 in disconnectable fluid communication with the vent line 44. The sensing line 92 also includes a second connector 96 that is releasably connected to the vent line 44 between the first valve 46 and the second flow controller 48 to dispose the sensing line 92 in disconnectable fluid communication with the vent line 44. For example, the first connector 94 and the second connector 96 may be quick-disconnect components such that the sensing line 92 may be periodically disconnected from the vent line 44.

Referring again to FIG. 15, the sensing line 92 also includes the third valve 52 disposed in fluid communication with the sensing line 92 and disposed between the first connector 94 and the second connector 96; a fourth flow controller 88 disposed in fluid communication with the sensing line 92 and disposed between the first connector 94 and the third valve 52; and a fifth flow controller 90 configured as a needle valve, disposed in fluid communication with the sensing line 92, and disposed between the second connector 96 and the third valve 52. That is, for this example, the third valve 52 and the fourth flow controller 88 may be configured as on/off valves and the fifth flow controller 90 is configured as a second needle valve. The system 10 also includes a pressure gauge 50 disposed between the third valve 52 and the fifth flow controller 90.

Therefore, for this example, the formation gas sampling and analysis equipment may be connected with a side loop quick disconnect, i.e., the first connector 94 and the second connector 96, so that a mobile gas analyzer 54 may be connected to the system 10 for analysis of a specific group of secondary energy storage devices 12.

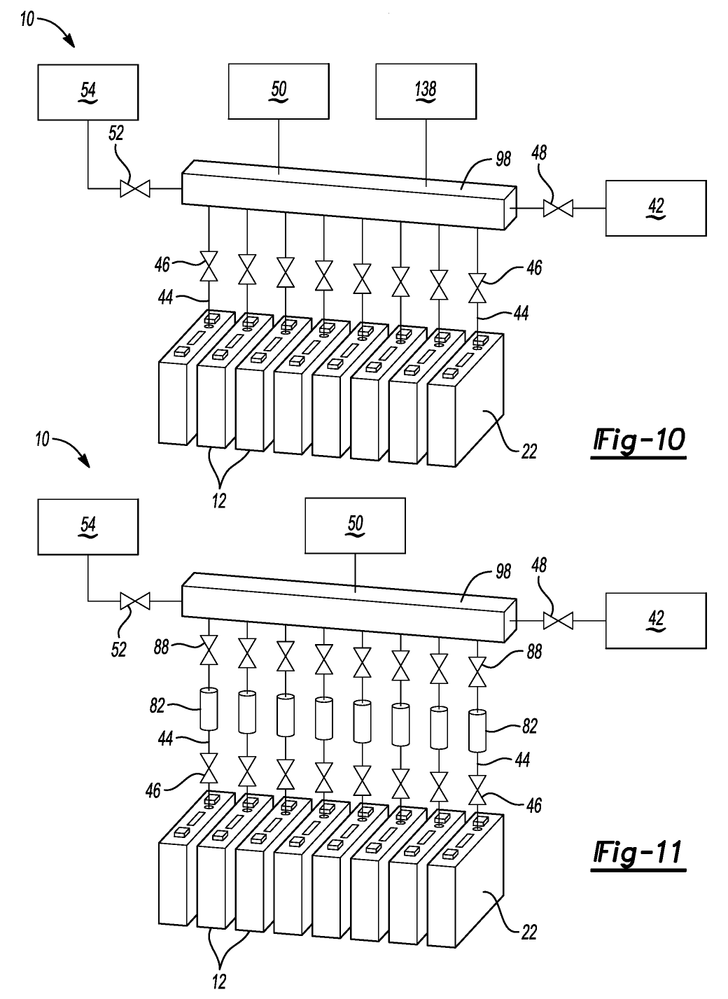

Referring now to FIG. 10, a formation gas analysis system 10 suitable for intermittent venting includes the formation chamber 34 defining the cavity 36 therein and configured for conducting 124 (FIG. 16) the formation cycle of each of the plurality of secondary energy storage devices 12 within the cavity 36 to generate a respective formation gas of each of the plurality of secondary energy storage devices 12. Each of the plurality of secondary energy storage devices 12 is disposed within the cavity 36 and has the rigid metal outer enclosure 22 that is sealed to define an interior, and intermittently unsealed during the formation cycle to intermittently vent the respective formation gas from the interior. The plurality of secondary energy storage devices 12 are arranged in parallel within the cavity 36.

Referring again to FIG. 10, the formation gas analysis system 10 also includes a sampling chamber 98 configured for collecting the respective formation gas of each of the plurality of secondary energy storage devices 12. The system 10 further includes a plurality of vent lines 44 each interconnecting a respective one of the plurality of secondary energy storage devices 12 and the sampling chamber 98 and configured for transmitting the respective formation gas from each of the plurality of secondary energy storage devices 12 to the sampling chamber 98. The system 10 also includes a temperature sensor 138 configured for measuring a temperature within the sampling chamber 98.

As shown in FIG. 10, the formation gas analysis system 10 also includes a plurality of first valves 46 each configured in fluid communication with the respective dedicated one of the plurality of secondary energy storage devices 12 and disposed between the respective, dedicated one of the plurality of secondary energy storage devices 12 on the sampling chamber 98 so that the respective formation gas of each of the plurality of secondary energy storage devices 12 is independently isolatable from the sampling chamber 98. The plurality of first valves 46 may each be configured as an on/off valve.

Referring again to FIG. 10, the system 10 also includes the vacuum pump 42 configured to remove the respective formation gas from the sampling chamber 98, a second flow controller 48 disposed between the sampling chamber 98 on the vacuum pump 42, and the gas analyzer 54 disposed downstream of the sampling chamber 98 and configured for analyzing the composition of the respective formation gas of each of the plurality of secondary energy storage devices 12. Further, the system 10 includes the third valve 52 disposed between the sampling chamber 98 and the gas analyzer 54, and a pressure gauge 50 disposed within the sampling chamber 98. In this example, the third valve 52 may be configured as an on/off valve.

Therefore, in operation, the system 10 of FIG. 10 is configured so that each secondary energy storage device 12 has a dedicated first valve 46 isolating each secondary energy storage device 12 from the sampling chamber 98. The gas analyzer 54, including the pressure gauge 50 and the temperature sensor 138, is connected to the sampling chamber 98 along with the vacuum pump 42 for evacuating the sampling chamber 98. As such, individual secondary energy storage devices 12 may be unsealed or opened to a pumped down sampling chamber 98, which may expand any formation gas that has been generated since a previous sample entered the sampling chamber 98. Each formation gas may be quantified via the pressure gauge 50 and temperature probe 38 and the composition of the formation gas may be measured via the gas analyzer 54. Once the formation gas of each of the secondary energy storage devices 12 is sampled and measured by the gas analyzer 54, the selected secondary energy storage device 12 may be isolated again and the sampling chamber 98 may be pumped down again before sampling the next secondary energy storage device 12.

Referring now to FIG. 11, in another exemplary aspect, the system 10 may include the plurality of vent canisters 82 each disposed in fluid communication with the respective one of the plurality of secondary energy storage devices 12 and the sampling chamber 98 along the respective one of the plurality of vent lines 44. Further, the system 10 may include a plurality of fourth flow controllers 88 each disposed in fluid communication with the respective, dedicated one of the plurality of vent lines 44 and disposed between the respective, dedicated one of the plurality of vent canisters 82 and the sampling chamber 98 so that the respective formation gas of each of the plurality of secondary energy storage devices 12 is independently isolatable from the sampling chamber 98. That is, for this exemplary aspect, instead of a single valve 46 disposed between each secondary energy storage device 12 and the sampling chamber 98, the system 10 may include a respective vent canister 82 or head space bottle for each secondary energy storage device 12 that is configured to collect and hold the formation gas before transmitting the formation gas to the sampling chamber 98.

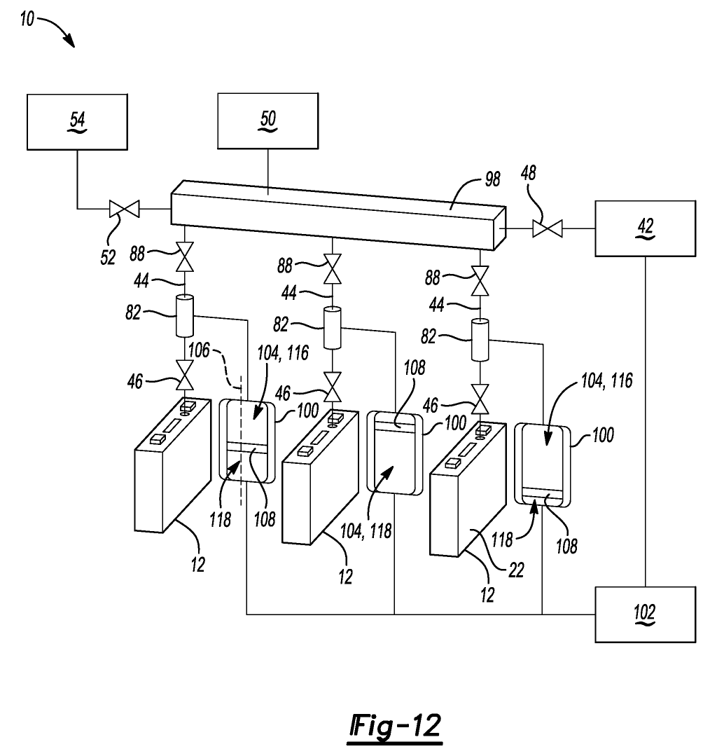

Referring now to FIG. 12, in another example, the system 10 may further include a plurality of diaphragms 100 each disposed in fluid communication with a respective one of the plurality of vent canisters 82 and the vacuum pump 42. The system 10 may also include a pressure regulator 102 disposed between and in fluid communication with each of the plurality of diaphragms 100 and the vacuum pump 42 and configured for controlling a pressure within the plurality of diaphragms 100 to thereby isobaric fully capture the respective formation gas of each of the plurality of secondary energy storage devices 12.

Each of the plurality of diaphragms 100 may define a pressure chamber 104 therein, may have a longitudinal axis 106, and may include a piston 108 translatable along the longitudinal axis 106 to thereby divide the pressure chamber 104 into a first portion 116 in fluid communication with the respective one of the plurality of vent canisters 82 and a second portion 118 isolated from the first portion 116 by the piston 108 and in fluid communication with the pressure regulator 102.

That is, each of the plurality of vent canisters 82 may be attached to a respective one of the plurality of diaphragms 100 to enable isobaric capture of the formation gas. Each of the plurality of diaphragms 100 may include the moving piston 108 that maintains pressure on both sides of the piston 108. Since each diaphragm 100 is connected to the pressure regulator 102 under controlled pressure, a control line may sense a position of each diaphragm 100 and may be used to trigger sampling or measurement of the formation gas. A volume of each diaphragm 100 may also be used with voltage points to quantify an amount of formation gas that has been generated during or at specific voltage milestones or windows during the formation cycle.

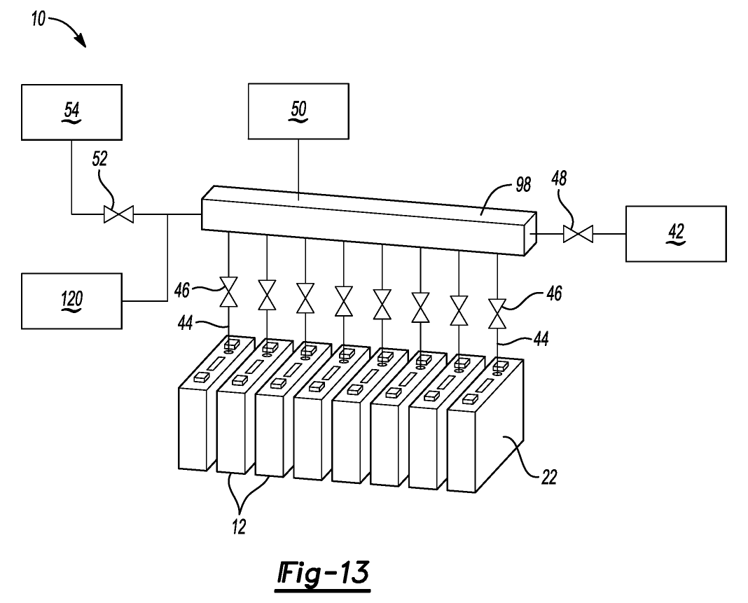

Referring now to FIG. 13, in another aspect, the formation gas analysis system 10 may further include a removable volume 120 of the respective formation gas. For example, the sampling chamber 98 or the plurality of vent canisters 82 may include the removable volume 120 so that certain formation gases can be removed and transported for additional analysis with other machine instrumentation. For instance, the plurality of vent canisters 82 may have a distinct measured volume and may contribute to accurate pressure measurements.

Therefore, in operation, the system 10 shown in FIG. 13 may analyze the respective formation gas for each of the plurality of secondary energy storage devices 12 in the gas analyzer 54. If one or more of the formation gases is suspect, an operator may remove the removable volume 120 for further analysis and replace the removable volume 120 with a replacement vent canister 82 while the gas analyzer 54 continues to analyze other respective formation gases.

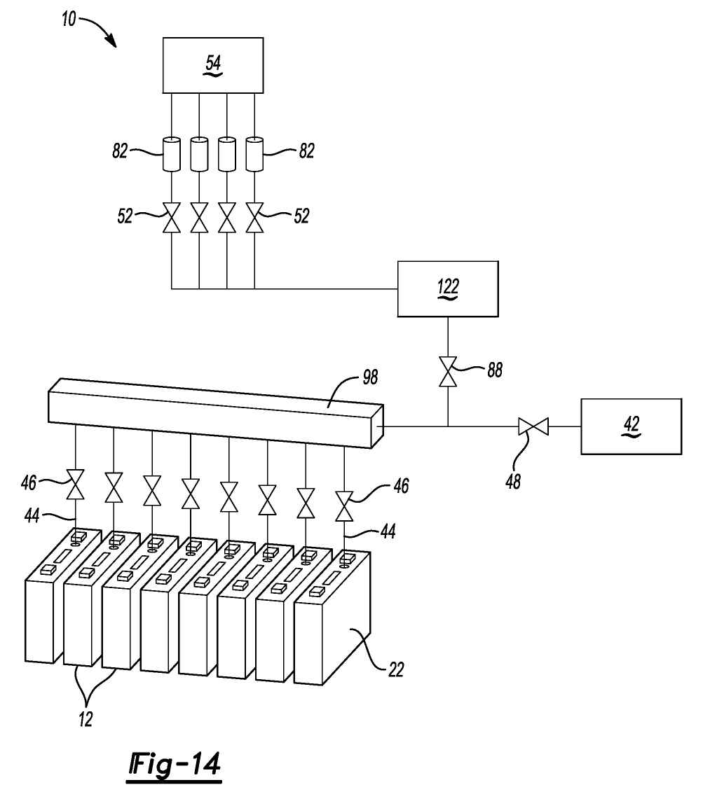

Referring now to FIG. 14, an exemplary formation gas analysis system 10 includes the formation chamber 34 defining the cavity 36 therein and configured for conducting 124 (FIG. 16) the formation cycle of each of the plurality of secondary energy storage devices 12 within the cavity 36 to generate the respective formation gas of each of the plurality of secondary energy storage devices 12. Each of the plurality of secondary energy storage devices 12 is disposed within the cavity 36 and has the rigid metal outer enclosure 22 that is sealed to define the interior, and intermittently unsealed during the formation cycle to intermittently vent the respective formation gas. The plurality of secondary energy devices 12 are arranged in parallel within the cavity 36.

Further, with continued reference to FIG. 14, the formation gas analysis system 10 includes the sampling chamber 98 configured for collecting the respective formation gas of each of the plurality of secondary energy storage devices 12. The system 10 also includes the plurality of vent lines 44 each interconnecting the respective one of the plurality of secondary energy storage devices 12 and the sampling chamber 98 and configured for transmitting the respective formation gas from each of the plurality of secondary energy storage devices 12 to the sampling chamber 98.

In addition, as shown in FIG. 14, the formation gas analysis system 10 also includes the plurality of first valves 46 each disposed in fluid communication with a respective, dedicated one of the plurality of secondary energy storage devices 12 and the sampling chamber 98 so that the respective formation gas of each of the plurality of secondary energy storage devices 12 is independently isolatable from the sampling chamber 98. The system 10 also includes the vacuum pump 42 configured to remove the formation gas from the sampling chamber 98.

The system 10 of FIG. 14 further includes the second flow controller 48 disposed between the sampling chamber 98 and the vacuum pump 42. In addition, the system 10 includes the gas analyzer 54 disposed downstream of the sampling chamber 98 between the sampling chamber 98 and the vacuum pump 42 and configured for analyzing the composition of the respective formation gas of each of the plurality of secondary energy storage devices 12.

For this aspect, the system 10 additionally includes the plurality of vent canisters 82 each disposed in fluid communication with the sampling chamber 98. Further, the formation system 10 includes a pressurizer 122 disposed between the sampling chamber 98 and the gas analyzer 54 and configured for conveying the respective formation gas from the sampling chamber 98 to at least one of the plurality of vent canisters 82. Further, the system 10 includes a plurality of third valves 52 each disposed between the pressurizer 122 and a respective one of the plurality of vent canisters 82. The system 10 also includes a fourth flow controller 88 disposed between the sampling chamber 98 and the pressurizer 122. For this example, each of the plurality of first valves 46, the second flow controller 48, third valve 52, and fourth flow controller 88 may be configured as an on/off valve.

By way of nonlimiting examples, the pressurizer 122 may be at least one of the step up pump 142 configured for pumping the respective formation gas from the sampling chamber 98 to the at least one of the plurality of vent canisters 82 and a pressurized inert gas that is distinct from the respective formation gas of each of the plurality of secondary energy storage devices 12. For example, the step up pump 142 may drive the formation gas into a respective vent canister 82 for each of the plurality of secondary energy storage devices 12 that could be sent through the gas analyzer 54. Such a configuration may enable sampling of secondary energy storage devices 12 that are closer in time with delayed gas analysis.

### Method of analyzing the formation gas

Referring now to FIG. 16, a method 14 of analyzing a formation gas includes conducting 124 the formation cycle of each of the plurality of secondary energy storage devices 12 by initially charging and discharging each of the plurality of secondary energy storage devices 12 within the formation chamber 34 defining the cavity 36 therein to generate the respective formation gas of each of the plurality of secondary energy storage devices 12. That is, conducting 124 may include initially charging and discharging each of the plurality of secondary energy storage devices 12 with, for example, the battery cycler 40 (FIG. 3) according to time and voltage schedules to thereby break-in the plurality of secondary energy storage devices 12. Each of the plurality of secondary energy storage devices 12 is disposed within the cavity 36 and has the rigid metal outer enclosure 22 that is unseeable during the formation cycle.

With continued reference to FIG. 16, the method 14 also includes removing 126 the respective formation gas from each of the plurality of secondary energy storage devices 12 through a respective one of a plurality of vent lines 44 in fluid communication with each of the plurality of secondary energy storage devices 12. More specifically, the method 14 may be suitable for open venting or intermittent venting processes. For example, for open venting processes, removing 126 may include continuously removing the respective formation gas of each of the plurality of secondary energy storage devices 12. Alternatively, for intermittent venting processes, removing 126 may include periodically removing the respective formation gas of each of the plurality of secondary energy storage devices 12 according to at least one of a time schedule and a voltage schedule.

In one aspect described with reference to FIG. 6 above and applicable for open venting of the formation gas, the method 14 may also include introducing 128 the reference gas 150 to the plurality of vent lines 44 through the mass flow controller 56 disposed in fluid communication with the plurality of vent lines 44. As such, for this aspect and as shown in FIG. 6, removing 126 may include collecting the reference gas 150 in the exhaust manifold 76 disposed in fluid communication with the plurality of vent lines 44 and the vacuum pump 42.

Further, referring again to FIG. 16, the method 14 includes conveying 130 the respective formation gas to the gas analyzer 54 disposed in fluid communication with each of the plurality of vent lines 44 and configured for determining the composition of the respective formation gas. For example, as described with reference to the aspects the formation gas analysis system 10 set forth in FIG. 6 above, conveying 130 the respective formation gas to the gas analyzer 54 may include routing the respective formation gas through one of a plurality of first valves 46 each disposed in fluid communication with a respective one of the plurality of vent lines 44 and spaced between a respective one of the plurality of pressure gauges 50 and a respective one of the secondary energy storage devices 12. Each of the plurality of first valves 46 may be the 6-port valve 146 that is transitionable between the filling position 58 and the measurement position 60 as described above with reference to FIGS. 7A and 7B according to at least one of a time schedule and a voltage schedule.

For example, at one or more certain prescribed times and/or voltage windows for the secondary energy storage device 12, the method 14 may include measuring and analyzing the formation gas. That is, the time schedule and/or voltage schedule may include periodic checkpoints for the formation cycle of the secondary energy storage device 12. By way of non-limiting examples, the 6-port valve 146 may transition from the filling position 58 to the measurement position 60 at time intervals, e.g., every number of minutes or hours, and/or at voltage levels, e.g., at a first, second, and third designated voltage milestone of the secondary energy storage device 12. As such, periodically in time or at certain voltage milestones of the secondary energy storage device 12, the composition of the formation gas may be measured to ascertain a time evolution of gas generation during the formation cycle. For example, formation gases produced at specific voltage windows may be indicative of parasitic side reactions and potential processes anomalies. Further, detection of or deviations in respective quantities or ratios of certain signature gases in the formation gas may correlate to certain manufacturing process anomalies or structural deviations for the secondary energy storage device 12.

As such, with continued reference to the system 10 illustrated in FIG. 6, the method 14 (FIG. 16) may further include independently exhausting 132 the respective formation gas of each of the plurality of secondary energy storage devices 12 by transitioning the selected 6-port valve 146 to the filling position 58 (FIG. 7A) such that the respective formation gas flows from the selected one of the plurality of secondary energy storage devices 12 to the exhaust manifold 76 through the sampling loop 62 and the reference gas 150 flows to the gas analyzer 54.

Referring again to FIG. 16, the method 14 also includes individually analyzing 134 a selected, respective formation gas of one of the plurality of secondary energy storage devices 12 over the formation cycle with the gas analyzer 54 while venting a non-selected, respective formation gas of another one of the plurality of secondary energy storage devices 12 with the vacuum pump 42 configured to remove the non-selected, respective formation gas from the cavity 36 to thereby analyze the composition of the selected, respective formation gas over the formation cycle. That is, an output of the method 14 may be a plot of the composition of the formation gas over time during the formation cycle, which may enable observation and monitoring of whether or how the composition of the formation gas evolves over time. Such knowledge of a change in compositional percentage or species of the formation gas over time may be useful for monitoring, predicting, and/or diagnosing process anomalies in high-volume manufacturing of the secondary energy storage device 12 as set forth above. In one non-limiting example, an evolution of the composition of the formation gas over the formation cycle may be visualized in a three-dimensional representation of a relationship between gas species, compositional values, and time.

Referring again to FIG. 16 and as described with reference to the aspect of the system 10 shown in FIG. 6, the method 14 may further include controlling 136 the head space pressure of each of the plurality of secondary energy storage devices 12 with the plurality of pressure gauges 50 each disposed in fluid communication with a respective one of the plurality of vent lines 44, and a plurality of needle valves 78 each disposed in fluid communication with a respective one of the plurality of vent lines 44 and disposed between the exhaust manifold 76 and the respective one of the plurality of pressure gauges 50. A respective one of the plurality of needle valves 78 may cooperate with the respective one of the plurality of pressure gauges 50 to control the head space pressure of each of the plurality of secondary energy storage devices 12 so that the gas analyzer 54 measures the heads pace pressure of one of the plurality of secondary energy storage devices 12 independently from measuring the heads pace pressure of another of the plurality of secondary energy storage devices 12.

The method 14 of FIG. 16 may further include independently exhausting 132 the respective formation gas of each of the plurality of secondary energy storage devices 12 by transitioning the selected6-port valve 146 to the filling position 58 (FIG. 7A) such that the respective formation gas flows from the selected one of the plurality of secondary energy storage devices 12 to the exhaust manifold 76 through the sampling loop 62 and the reference gas 150 flows to the gas analyzer 54.

For the aspect of the system 10 shown in FIG. 6, the method 14 (FIG. 16) may further include independently assessing 140 (FIG. 16) the respective formation gas of each of the plurality of secondary energy storage devices 12 with the gas analyzer 54 by transitioning the 6-port valve 146 to the measurement position 60 such that the respective formation gas and the reference gas 150 in the sampling loop 62 flows to the gas analyzer 54 and a remainder of the respective formation gas that is not in the sampling loop 62 is drawn from the selected one of the plurality of secondary energy storage devices 12 to the exhaust manifold 76 by the vacuum pump 42. That is, independently assessing 140 may include ensuring that the respective formation gas from the selected one of the plurality of secondary energy storage devices 12 is transmitted to the gas analyzer 54 and each respective formation gas of the remainder of the plurality of secondary energy storage devices 12 is not transmitted to the gas analyzer 54.

Referring again to FIG. 16 and described with reference to the aspect of the formation gas analysis system 10 shown in FIG. 8, which may also be suitable for open venting processes, conveying 130 may include routing the respective formation gas of each of the plurality of secondary energy storage devices 12 to the gas multiplexer 80 configured for sequentially analyzing the composition of the respective formation gas according to at least one of the time schedule and the voltage schedule. The gas multiplexer 80 may be disposed in fluid communication with each of the plurality of vent lines 44 and the gas analyzer 54. That is, at one or more certain prescribed times and/or voltage windows for the secondary energy storage device 12, the method 14 may include measuring and analyzing the formation gas via the multiplexer 80. That is, the time schedule and voltage schedule may include periodic checkpoints for the formation cycle of the secondary energy storage device 12. As such, periodically in time or at certain voltage milestones of the secondary energy storage device 12, the composition of the formation gas may be measured to ascertain a time evolution of gas generation during the formation cycle.

For this aspect of the system 10 of FIG. 8, individually analyzing 134 (FIG. 16) may include arranging the plurality of secondary energy storage devices 12 in parallel within the cavity 36 of the formation chamber 34 and measuring a composition of the respective formation gas of one of the plurality of secondary energy storage devices 12 at a time. The gas multiplexer 80 may be disposed in fluid communication with each of the plurality of vent lines 44 between the respective one of the plurality of first valves 46; and the respective one of the plurality of second flow controllers 48 each configured as a needle valve and each disposed in fluid communication with the respective one of the first valves 46 and the vacuum pump 42 along the respective one of the plurality of vent lines 44.

Further, as shown in FIG. 8, for this aspect of the method 14 (FIG. 16), the plurality of vent canisters 82 may each be disposed in fluid communication with the respective one of the plurality of secondary energy storage devices 12 and the respective one of the plurality of first valves 46. The plurality of pressure gauges 50 may each be disposed on the respective one of the plurality of vent lines 44 between the respective one of the plurality of first valves 46 and the respective one of the plurality of second flow controllers 48.

This aspect of the method 14 (FIG. 16) may be suitable for applications requiring multiple secondary energy storage devices 12 arranged in parallel and connected to multiplexed vent lines 44 that are fed to a single gas analyzer 54, which may enable analysis of comparatively more secondary energy storage devices 12.

Therefore, in summary, the formation gas analysis system 10 and method 14 may be useful for applications requiring measurement, analysis, and monitoring of the composition of the formation gas produced by the secondary energy storage device 12 during the first or formation cycle and for applications requiring secondary energy storage devices 12 having excellent quality and robust operational integrity during operation under various conditions. In particular, the system 10 and method 14 may be useful for applications requiring in-process quality monitoring during manufacturing operations of secondary energy storage devices 12. As such, the method 14 and system 10 may be useful for applications requiring prismatic lithium ion secondary batteries having excellent electrical conductivity, mechanical integrity, specific energy capacity, performance, manufacturing cost, and operating life.

The described embodiments of the present disclosure are intended to serve as non-limiting examples, and other embodiments may take various and alternative forms. In addition, the appended drawings are not necessarily to scale, and may present a somewhat simplified representation of various features of the present disclosure, including, for example, specific dimensions, orientations, locations, and shapes. Details associated with such features will be determined in part by the intended application and use environment of the described embodiments.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “substantially”, “generally”, “approximately”, etc., may be used herein in the sense of “at, near, or nearly at”, or “within 0-5 % of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function. In addition, the use of ordinals such as first, second and third does not necessarily imply a ranked sense of order, but rather may merely distinguish between multiple instances of an act or structure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A formation gas analysis system comprising:
a formation chamber defining a cavity therein;
a secondary energy storage device disposed within the cavity and having a rigid metal outer enclosure that is at least partially unsealed;
wherein the formation chamber is configured for conducting a formation cycle of the secondary energy storage device within the cavity to generate a formation gas, wherein the rigid metal outer enclosure remains at least partially unsealed during the formation cycle;
a vacuum pump configured to remove the formation gas from the secondary energy storage device;
a vent line interconnecting the secondary energy storage device and the vacuum pump and configured for transmitting the formation gas from the secondary energy storage device;
a first valve and a second flow controller each disposed in fluid communication with the vent line, spaced apart from one another along the vent line, and disposed between the formation chamber and the vacuum pump;
a pressure gauge disposed between the first valve and the second flow controller on the vent line;
a third valve disposed in fluid communication within the vent line and disposed between the pressure gauge and the second flow controller; and
a gas analyzer disposable in fluid communication with the vent line and configured for determining a composition of the formation gas.

2. The formation gas analysis system of claim 1, further including a mass flow controller disposed in fluid communication with the vent line between the secondary energy storage device and the gas analyzer and configured for introducing a reference gas to the vent line.

3. The formation gas analysis system of claim 2, wherein the first valve is disposed between the secondary energy storage device and the pressure gauge on the vent line;
wherein the first valve is a 6-port valve that is transitionable between a filling position and a measurement position;
wherein the 6-port valve includes a sampling loop configured for transmitting a sample of the formation gas within the 6-port valve and defines:
a first port in fluid communication with the secondary energy storage device;
a second port in fluid communication with the sampling loop and the first port when the 6-port valve is disposed in the filling position;
a third port in fluid communication with the gas analyzer;
a fourth port in fluid communication with the mass flow controller and the gas analyzer when the 6-port valve is disposed in the filling position;
a fifth port in fluid communication with the sampling loop and the vacuum pump when the 6-port valve is disposed in the filling position; and
a sixth port in fluid communication with the vacuum pump and the fifth port when the 6-port valve is disposed in the filling position; and
wherein:
the first port is in fluid communication with the secondary energy storage device, the sixth port, and the vacuum pump when the 6-port valve is disposed in the measurement position;
the second port is in fluid communication with the sampling loop, the third port, and the gas analyzer when the 6-port valve is disposed in the measurement position;
the third port is in fluid communication with the gas analyzer and the second port when the 6-port valve is disposed in the measurement position;
the fourth port is in fluid communication with the mass flow controller, the fifth port, and the sampling loop when the 6-port valve is disposed in the measurement position;
the fifth port is in fluid communication with the sampling loop, the fourth port, and the mass flow controller when the 6-port valve is disposed in the measurement position; and
the sixth port is in fluid communication with the first port and the vacuum pump when the 6-port valve is disposed in the measurement position.

4. The formation gas analysis system of claim 3, further including:
a plurality of secondary energy storage devices disposed within the cavity and each configured to generate a respective formation gas;
a plurality of vent lines each disposed in fluid communication with a respective one of the plurality of secondary energy storage devices and configured for transmitting the respective formation gas of each of the plurality of secondary energy storage devices from the cavity;
an exhaust manifold disposed in fluid communication with each of the plurality of vent lines and configured to collect the respective formation gas generated by each of the plurality of secondary energy storage devices and form an aggregated gas;
a plurality of 6-port valves each disposed in fluid communication with the mass flow controller, a respective one of the plurality of vent lines, and the gas analyzer as the plurality of 6-port valves each transition between the filling position and the measurement position;
a plurality of pressure gauges each disposed on a respective one of the plurality of vent lines between the exhaust manifold and a respective one of the plurality of 6-port valves; and
a plurality of needle valves each disposed in fluid communication with the exhaust manifold and a respective one of the plurality of vent lines and disposed between a respective one of the plurality of pressure gauges and the exhaust manifold along the respective one of the plurality of vent lines.

5. The formation gas analysis system of claim 4, wherein the respective formation gas of each of the plurality of secondary energy storage devices is independently measurable by the gas analyzer.

6. The formation gas analysis system of claim 4, wherein a respective one of the plurality of needle valves cooperates with a respective one of the pressure gauges for each of the plurality of secondary energy storage devices to control a head space pressure of each of the plurality of secondary energy storage devices so that the gas analyzer measures the head space pressure of one of the plurality of secondary energy storage devices independently from measuring the head space pressure of another of the plurality of secondary energy storage devices.

7. The formation gas analysis system of claim 4, wherein the respective formation gas from a selected one of the plurality of secondary energy storage devices is transmitted to the gas analyzer and the respective formation gas of a remainder of each of the plurality of secondary energy storage devices is not transmitted to the gas analyzer.

8. A formation gas analysis system comprising:
a formation chamber defining a cavity therein;
a plurality of secondary energy storage devices disposed within the cavity and each having a rigid metal outer enclosure that is unsealed;
wherein the formation chamber is configured for conducting a formation cycle of each of the plurality of secondary energy storage devices within the cavity to generate a respective formation gas of each of the plurality of secondary energy storage devices, wherein the rigid metal outer enclosure remains unsealed during the formation cycle;
a vacuum pump configured to remove the respective formation gas from each of the plurality of secondary energy storage devices;
a plurality of vent lines interconnecting each of the plurality of secondary energy storage devices and the vacuum pump and configured for transmitting the respective formation gas from each of the plurality of secondary energy storage devices;
a plurality of first valves each disposed in fluid communication with a respective one of the plurality of vent lines and disposed between the formation chamber and the vacuum pump;
a plurality of second flow controllers each disposed in fluid communication with a respective one of the plurality of vent lines, spaced apart from a respective one of the plurality of first valves along the respective one of the plurality of vent lines, and disposed between the formation chamber and the vacuum pump;
a plurality of pressure gauges each disposed between the respective one of the plurality of first valves and the respective one of the plurality of second flow controllers on the respective one of the plurality of vent lines;
a gas analyzer configured for analyzing a composition of the respective formation gas of each of the plurality of secondary energy storage devices; and
a gas multiplexer disposed in fluid communication with the gas analyzer and configured for sequentially conveying the respective formation gas of each of the plurality of secondary energy storage devices to the gas analyzer;
wherein the gas multiplexer is disposed in fluid communication with each of the plurality of vent lines and conveys the respective formation gas of a single one of the plurality of secondary energy storage devices to the gas analyzer at a time.

9. The formation gas analysis system of claim 8, wherein the plurality of secondary energy storage devices are arranged in parallel within the cavity;
wherein the formation gas analysis system further includes a plurality of vent canisters each disposed in fluid communication with a respective one of the plurality of secondary energy storage devices;
wherein each of the plurality of first valves is disposed in fluid communication with a respective one of the plurality of vent canisters; and
wherein each of the plurality of second flow controllers is configured as a needle valve.

10. A method of analyzing a formation gas, the method comprising:
conducting a formation cycle of each of a plurality of secondary energy storage devices by initially charging and discharging each of the plurality of secondary energy storage devices within a formation chamber defining a cavity therein to generate a respective formation gas of each of the plurality of secondary energy storage devices, wherein each of the plurality of secondary energy storage devices is disposed within the cavity and has a rigid metal outer enclosure that is unsealable during the formation cycle;
removing the respective formation gas from each of the plurality of secondary energy storage devices through a respective one of a plurality of vent lines in fluid communication with each of the plurality of secondary energy storage devices;
conveying the respective formation gas to a gas analyzer disposed in fluid communication with each of the plurality of vent lines and configured for determining a composition of the respective formation gas; and
individually analyzing a selected, respective formation gas of one of the plurality of secondary energy storage devices with the gas analyzer over the formation cycle while venting a non-selected, respective formation gas of another one of the plurality of secondary energy storage devices with a vacuum pump configured to remove the non-selected, respective formation gas from the cavity to thereby analyze the composition of the selected, respective formation gas over the formation cycle.

11. The method of claim 10, further including introducing a reference gas to the plurality of vent lines through a mass flow controller disposed in fluid communication with the plurality of vent lines.

12. The method of claim 11, wherein removing includes collecting the reference gas in an exhaust manifold disposed in fluid communication with the plurality of vent lines and the vacuum pump.

13. The method of claim 12, further including controlling a head space pressure of each of the plurality of secondary energy storage devices with:
a plurality of pressure gauges each disposed in fluid communication with a respective one of the plurality of vent lines; and
a plurality of needle valves each disposed in fluid communication with the respective one of the plurality of vent lines and disposed between the exhaust manifold and a respective one of the plurality of pressure gauges;
wherein a respective one of the plurality of needle valves cooperates with a respective one of the plurality of pressure gauges to control the head space pressure of each of the plurality of secondary energy storage devices so that the gas analyzer measures the head space pressure of one of the plurality of secondary energy storage devices independently from measuring the head space pressure of another of the plurality of secondary energy storage devices.

14. The method of claim 13, wherein conveying the respective formation gas to the gas analyzer includes routing the respective formation gas through one of a plurality of first valves each disposed in fluid communication with a respective one of the plurality of vent lines and spaced between a respective one of the plurality of pressure gauges and a respective one of the secondary energy storage devices;
wherein each of the plurality of first valves is a 6-port valve that is transitionable between a filling position and a measurement position according to at least one of a time schedule and a voltage schedule;
wherein the 6-port valve includes a sampling loop configured for transmitting a sample of the formation gas within the 6-port valve and defines:
a first port in fluid communication with the respective secondary energy storage device;
a second port in fluid communication with the sampling loop and the first port when the 6-port valve is disposed in the filling position;
a third port in fluid communication with the gas analyzer;
a fourth port in fluid communication with the mass flow controller and the gas analyzer when the 6-port valve is disposed in the filling position;
a fifth port in fluid communication with the sampling loop and the vacuum pump when the 6-port valve is disposed in the filling position; and
a sixth port in fluid communication with the vacuum pump and the fifth port when the 6-port valve is disposed in the filling position; and
wherein:
the first port is in fluid communication with the respective secondary energy storage device, the sixth port, and the vacuum pump when the 6-port valve is disposed in the measurement position;
the second port is in fluid communication with the sampling loop, the third port, and the gas analyzer when the 6-port valve is disposed in the measurement position;
the third port is in fluid communication with the gas analyzer and the second port when the 6-port valve is disposed in the measurement position;
the fourth port is in fluid communication with the mass flow controller, the fifth port, and the sampling loop when the 6-port valve is disposed in the measurement position;
the fifth port is in fluid communication with the sampling loop, the fourth port, and the mass flow controller when the 6-port valve is disposed in the measurement position; and
the sixth port is in fluid communication with the first port and the vacuum pump when the 6-port valve is disposed in the measurement position.

15. The method of claim 14, further including independently exhausting the respective formation gas of each of the plurality of secondary energy storage devices by transitioning a selected 6-port valve to the filling position such that the respective formation gas flows from a selected one of the plurality of secondary energy storage devices to the exhaust manifold through the sampling loop and the reference gas flows to the gas analyzer.

16. The method of claim 15, further including independently assessing the respective formation gas of each of the plurality of secondary energy storage devices with the gas analyzer by transitioning the selected 6-port valve to the measurement position such that the respective formation gas and the reference gas in the sampling loop flows to the gas analyzer and a remainder of the respective formation gas that is not in the sampling loop is drawn from the selected one of the plurality of secondary energy storage devices to the exhaust manifold by the vacuum pump.

17. The method of claim 16, wherein independently assessing includes ensuring that the respective formation gas from a selected one of the plurality of secondary energy storage devices is transmitted to the gas analyzer and each respective formation gas of a remainder of the plurality of secondary energy storage devices is not transmitted to the gas analyzer.

18. The method of claim 10, wherein conveying includes routing the respective formation gas of each of the plurality of secondary energy storage devices to a gas multiplexer configured for sequentially analyzing a composition of the respective formation gas according to at least one of a time schedule and a voltage schedule; and
wherein the gas multiplexer is disposed in fluid communication with each of the plurality of vent lines and the gas analyzer.

19. The method of claim 18, wherein individually analyzing includes arranging the plurality of secondary energy storage devices in parallel within the cavity of the formation chamber and measuring a composition of the respective formation gas of one of the plurality of secondary energy storage devices at a time; and
wherein the gas multiplexer is disposed in fluid communication with each of the plurality of vent lines between:
a respective one of a plurality of first valves; and
a respective one of a plurality of second flow controllers each configured as a needle valve and each disposed in fluid communication with a respective one of the first valves and the vacuum pump along a respective one of the plurality of vent lines;
wherein a plurality of vent canisters are each disposed in fluid communication with a respective one of the plurality of secondary energy storage devices and a respective one of the plurality of first valves; and
wherein a plurality of pressure gauges are each disposed on a respective one of the plurality of vent lines between a respective one of the plurality of first valves and a respective one of the plurality of second flow controllers.

20. A vehicle including a secondary energy storage device having a formation gas analyzed by the method of claim 10.
